(19) United States
(12) Patent Application Publication
(10) Pub. No.: US 2012/0202523 A1
(43) Pub. Date: Aug. 9, 2012

(54) SYSTEM AND A METHOD FOR EMPLOYING SWARMS OF ELECTRONIC DEVICES TO LOCATE SURVIVORS IN THE EVENT OF CATASTROPHIC STRUCTURE COLLAPSE

(75) Inventors: Gregory Allen Kohring, Hennef (DE); Luigi Lo Iacono, Bonn (DE)

(73) Assignee: NEC EUROPE LTD., Sankt Augustin (DE)

(21) Appl. No.: 13/383,098

(22) PCT Filed: Jul. 10, 2009
(86) PCT No.: PCT/EP2009/058797

§ 371 Date: Apr. 18, 2012

(51) Int. Cl. H04W 4/02

(52) U.S. Cl. 455/456.2

(57) ABSTRACT

The present invention provides a system and method for locating survivors after a collapse of a man-made structure. A plurality of electronic devices is distributed in the structure, the electronic devices comprising a wireless transmitter. The devices self-organize into a network and record the positions of the electronic devices in three dimensions relative to each other using a known position of at least one of the electronic devices. Upon the collapse of the structure, at least one additional electronic device is introduced into the network and the positions of the electronic devices are re-calculated using the known position of the additional electronic device. Potential positions of survivors are determined using the re-calculated positions of the electronic devices after the collapse.

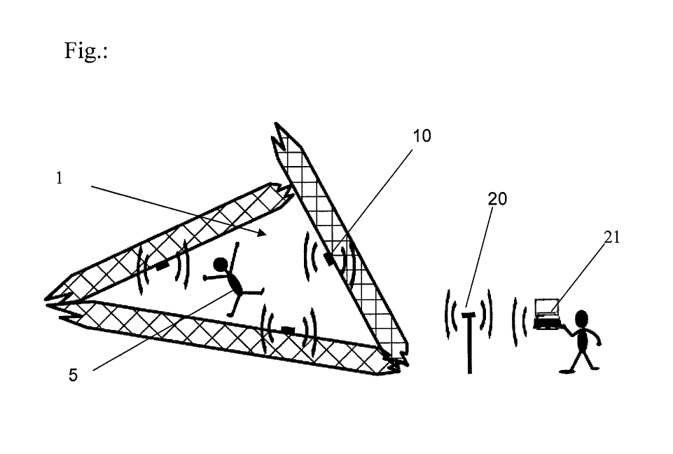

The present invention relates to a system and method for locating and rescuing survivors after a large man-made structure has collapsed catastrophically. In particular, the invention relates to identifying and locating hollow spaces after the collapse of the structure in which survivors may be located.

Locating and rescuing the survivors after a large man-made structure has collapsed catastrophically is a race against time. Important questions rescuers have to ask when approaching the collapsed structure or building are: Where are the survivors buried? and: Where should one start digging in order to have the best chance of saving the largest possible number of lives?

One standard approach today is to use specially trained dogs to locate survivors after a structure has collapsed. However, this approach is restricted to locating survivors towards positions close to the surface of a heap of rubble. Even highly trained dogs cannot locate survivors deeper than a few meters.

In U.S. Pat. No. 4,998,282, the use of borescopes to penetrate the rubble and to find survivors is described. The borescope system is described to ascertain the survival of victims, detect the conditions of circumstances to which the victims are confined, and to give appropriate medical treatment to survivors, if any. However, this technique is mainly used in conjunction with other technologies, since it is not practical to make a large number of boreholes into a heap of rubble.

Furthermore, the use of cell phones equipped with a special chip which responds automatically when contacted by emergency workers is described in US-A-2006/0166696. When rescuers approach a collapsed structure, signals which are detected by the cell phones are sent out. A cell phone authenticating the signal will respond and transmit its location. This approach, however, requires all phones to be equipped with a special chip and would further require all building occupants to acquire such a phone. Furthermore, the people always have to have their phone with them, which is not always guaranteed, in particular when people are working in the building. The use of cell phones to locate any survivors also has severe privacy problems. In order to make sure all rescue crews have the appropriate authentication credentials to contact the cell phones in an emergency, the credentials would have to be widely distributed, increasing the likelihood that they would fall into the wrong hands. Anyone who had the appropriate credentials could then essentially query any phone to find its location and track its owner.

There is thus a need for a method and system to locate survivors which overcomes the above problems. In particular, the system and method should be independent of devices that have to be carried by the occupants of the structure and should further allow location of survivors throughout the collapsed building. Additionally, the system preferably should be capable of determining the state of health of the potential survivors.

These objects are achieved with the features of the claims.

After the collapse of a man-made structure or building potential survivals are located with a high probability in hollow spaces that provide sufficient space. Thus, in order to be able to locate potential survivors, hollow spaces of sufficient size should be localized. Preferably, it should then be possible to determine whether or not any survivors are present in the hollow spaces found.

The present invention is based on the idea to install tiny electronic devices in a structural building which have a high probability of surviving a catastrophic collapse due to their small size and that are able to determine and to provide information on their location after the collapse. The tiny electronic devices have a high probability to be co-located within a hollow space occupied by a survivor. Thus, the presence of such a tiny device or any accumulation or clustering of the tiny devices in certain locations may be an indication of a hollow space where a potential survivor may be located.

Accordingly, according to the present invention, the method for locating survivors after a collapse of a man-made structure comprises distributing a plurality of electronic devices in the structure, the electronic devices each comprising a wireless transmitter. Preferably, the electronic devices further comprise an environmental sensor, such as an infrared sensor, an acoustic sensor or a video sensor, in order to determine if any survivors are in the same hollow space as the electronic device. The environmental sensor may further be able to determine the ambient conditions of the hollow space, e.g. temperature or oxygen level, in order to ascertain the chances a survivors will still be alive when rescued.

The electronic devices then self-organize into a network to record the positions of the electronic devices in three dimensions relative to each other. In order to do so, at least one of the electronic device should have information on its location. To determine the locations of the other devices relative to each other and/or relative to the structure, a bootstrapping method may be used, based on triangulation techniques or. Alternatively, GPS coordinates may be given to each electronic device when it is deployed, or each electronic device may be provided with a GPS receiver. Upon a collapse of the structure, at least one additional electronic device is introduced into the network. Based on the known position of the additional electronic device, the position of the previously installed electronic devices may be re-calculated. The re-calculated positions of the electronic devices after the collapse may be used to determine a position of a potential survivor. By calculating the change of position of each electronic device before and after the collapse, the trajectory of different parts of the structure during the collapse may further be determined. This information on how the structure collapsed may be important when deciding how to remove the top layer of the rubble in order not to jeopardize the lives of those who survived the initial collapse.

The present invention further provides a system for locating survivors after a collapse of a man-made structure, comprising a plurality of electronic devices each comprising a wireless transmitter adapted to self-organize into a network for recording the relative positions of each device in the network. The electronic devices preferably are minute stand-alone devices of a few cubic millimetres in size and are preferably composed of a system-on-a-chip (SOC) technology together with a wireless transmitter and, optionally, one or more environmental sensors. The transmitter preferably has a range in the order of 10 meter.

In the following, an embodiment of the present invention is described with reference to the appended FIGURE that schematically shows the use of a system for locating survivors according to an embodiment of the invention.

The electronic devices used according to the embodiment conveniently are called “Specks”. These Specks are minute stand-alone devices of a few cubic millimetres in size; preferably 100 cubic millimetres or less. They are composed of SOC (system-on-a-chip) technology together with a wireless transmitter and one ore more environmental sensors. Although currently rather expensive at several hundred dollars a piece, their price is expected to drop rapidly to maybe less than one dollar when they enter mass production. The wireless transmitters usually have a range on the order of 1-10 meters and swarms of them can self-organize to form a network, called a SpeckNet.

In order to help locating survivors of a catastrophic structure collapse, large members of Specks will be distributed throughout the target structure. The Specks can then self-organize into a network, recording their relative locations in three dimensions with respect to each other. To determine their locations relative to the structure, a bootstrapping method is used, whereby at least one Speck, and preferably a number of Specks are informed of their location within the structure. Using triangulation techniques, this information is passed on to the other Specks. Alternatively, one can give GPS coordinates to each Speck when it is deployed, or each Speck may be provided with a GPS receiver.

When the target structure collapses, the Specks will have a high probability of surviving the collapse, mainly because of its tiny size, and to be collocated in hollow spaces along with human survivors. This situation is schematically shown in the FIGURE. If a hollow space 1 of a sufficient size was maintained during the collapse, this hollow space 1 provides a high chance for people 5 to survive. Thus, locating survivors may be mapped onto the problem of locating hollow spaces of sufficient size and determining whether or not they are occupied by vital casualties. If rescuers 21 arrive they will bring with them additional Specks or larger-scale and more powerful devices 20, which will join the SpeckNet of the survivor Specks 10. These new Specks 20 will transmit new coordinates to the original Specks 10 that can be used to calculate their new relative positions in the SpeckNet. This information, preferably along with the original coordinates, is transmitted back to the new Specks 20 which the rescuers 21 can read and use to recreate the original structure. High performance computer simulations may then be used to determine the path to different parts of the structure or building followed as they collapsed. Knowing how the structure collapsed may be important when the deciding how to remove the top layer of the rubble in order not to jeopardize the lives of those who survived the initial collapse.

The Specks may also use their associated sensors to determine if any survivors are in the same hollow space as themselves. The types of sensors that could be used for this purpose include, but is not limited to: infrared sensors, acoustic sensors and video sensors, etc. If survivors are detected, this information along with the Specks' location is transmitted through the network to the rescuers. The sensors associated with the Speck might also determine the ambient conditions of the hollow space, e.g. temperature or oxygen level, in order to ascertain the chances a survivor will still be alive when rescued. Since the small size of the Specks means that they will have a very good chance of surviving a structural collapse and since they will be cheap enough, one can deploy enough of them to ensure that they will, with high probability, be co-located within a hollow space occupied by a survivor. Using the properties of a self-organizing SpeckNet, it is possible to locate hollow spaces and the survivors in a heap of rubble.

While the invention has been illustrated and described in detail in the foregoing description and the FIGURE, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practising the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures can not be used to advantage.

1. Method for locating survivors after a collapse of a man-made structure, comprising:
distributing a plurality of electronic devices comprising a wireless transmitter in the structure;
self-organizing the devices into a network and recording the positions of the electronic devices in three dimensions relative to each other using a known position of at least one of the electronic devices;
upon the collapse of the structure, introducing at least one additional electronic device into the network and re-calculating the positions of the electronic devices using the known position of the additional electronic device; and
determining a potential position of survivors using the re-calculated positions of the electronic devices after the collapse.

2. Method according to claim 1, wherein the position of the electronic devices is calculated using a triangulation technique.

3. Method according to claim 1, wherein the position of at least one of the electronic devices and/or the additional electronic device is determined using a GPS receiver provided in the at least one electronic device and/or the additional electronic devices.

4. Method according to claim 1, further comprising calculating the change of position of each electronic device before and after the collapse for determining the path of different parts of the structure during the collapse.

5. Method according to claim 1, wherein at least some of the electronic devices comprise an environmental sensor.

6. Method according to claim 5, further comprising determining the presence of a survivor in the proximity of an electronic device using the environmental sensor.

7. System for locating survivors after a collapse of a man-made structure comprising a plurality of electronic devices comprising a wireless transmitter distributed in the structure, the devices being adapted to self-organize into a network and to record their positions in three dimensions relative to each other using a known position of at least one of the devices, the system further comprises at least one additional electronic device adapted to be introduced into the network such that the positions of the electronic devices can be re-calculated after the collapse of the structure using the known position of the additional electronic device.

8. System according to claim 7, wherein at least some of the electronic devices comprise an environmental sensor.

9. System according to claim 7, wherein the electronic devices are system-on-a-chip devices.

10. System according to claim 7, wherein the size of each electronic device is about 100 cubic millimetres or smaller.

11. System according to claim 7, wherein the wireless transmitter in each electronic device has a range of about 1-10 meters.
